(19) United States
(12) Patent Application Publication
(10) Pub. No.: US 2006/0089914 A1
(43) Pub. Date: Apr. 27, 2006

(54) Apparatus, systems and methods for compensating broadcast sources

(76) Inventors: John Shiel, Greystones (IE); Connor Ryan, Killbeg (IE); Colm Dunphy, Waterford (IE)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(21) Appl. No.: 11/215,724

(22) Filed: Aug. 30, 2005

Related U.S. Application Data
(60) Provisional application No. 60/605,605, filed on Aug. 30, 2004.

(51) Int. Cl. G06Q 99/00

(52) U.S. Cl. 705/52

(57) ABSTRACT

In one aspect, the invention relates to a method of compensating a broadcast source. The method includes the steps of delivering a plurality of content elements originating from a broadcast source to a receiver; generating a playout list of the plurality of content elements, identifying the broadcast source, identifying one content element of the plurality of content elements; and compensating the broadcast source if the user of the receiver purchases an item associated with the one content element.

### RELATED APPLICATION

This application claims priority to U.S. Provisional Application 60/605,605 filed on Aug. 30, 2004, the disclosure of which is herein incorporated by reference in its entirety.

### FIELD OF THE INVENTION

The invention relates generally to the field of advertising and content delivery. Specifically, the invention relates to distribution and compensation schemes using advertising/content source recognition/identification in combination with advertiser/broadcaster compensation schemes.

### BACKGROUND OF THE INVENTION

Radio and television have been the traditional vehicles for delivering audio and visual content to the public. Historically, a broadcaster such as a radio station or a television company have generated revenue primarily from advertising. Interleaving conventional ads and commercials between various audio and audiovisual broadcasts continues to be a source of revenue to the companies that sell broadcast time. However, the broadcaster does not directly generate revenue from the broadcast of the actual audio or audiovisual creation. In fact, the broadcasts, i.e., television shows or music, which support the advertising content, generally represent a cost to the broadcaster in the form of royalty/performance rights fees. This feature of the broadcast source compensation model remains unchanged, even with new advances in technology.

Technological advances such as the Internet now provide additional channels to deliver audio and visual programming. In spite of these new channels, the principal broadcast audience still relies on conventional radio and television programming as their main entertainment and information sources. As such, advertiser and marketing departments still focus on this demographic to sell goods and services. Similarly, even with advances in technology, the business model for broadcasters still remains focused on generating revenue from advertisers in exchange for providing targeted content. This limits the amount of money that broadcast sources can generate.

There are also limitations associated with this business model from the consumer perspective. If a user hears a program on the radio and wishes to purchase a particular portion of the program, they must first be able to identify the content, record the details about the artist and then try to determine the source of the content. If the user is successful in following these steps, they must then locate the content and buy it. This process is time consuming and cost intensive. In addition, no benefit is received from the broadcaster that provided the broadcast content to the consumer. Accordingly, a need therefore exists to develop additional compensation schemes that are easier to use and offer new business options to broadcasters.

### SUMMARY OF THE INVENTION

Although broadcasters are responsible for disseminating much of the cutting edge content and entertainment to the population, they often remain under compensated for all of the services they provide. Accordingly, a need exists to provide additional compensation schemes that more fully compensate broadcast sources. In response to this need, the aspects and embodiments disclosed herein offer new compensation schemes in the form of business methods, systems and devices that enable broadcasters to share in the revenue of sales from songs, albums, services, advertising and merchandise.

As a result, the broadcaster of a content element such as a song, movie or advertisement, can be compensated for the initial content broadcast in form of a percentage of the revenue associated with the sale of downloadable versions of the media or tickets to the movie bought through a broadcaster specific communication device, webpage, or other online mechanism. Additional details of the invention are described in the figures and description provided below.

In one aspect, the invention relates to a method of compensating a broadcast source. The method includes the steps of delivering a plurality of content elements originating from a broadcast source to a receiver, generating a playout list of the plurality of content elements, identifying the broadcast source, identifying one content element of the plurality of content elements, and compensating the broadcast source (if the user) of the receiver purchases an item associated with the one content element. In one embodiment, the receiver is a user or potential consumer. In another embodiment, the receiver is an electronic device. The playout list is generated by tracking changes in the plurality of content elements over time to identify different content elements in one embodiment. The method can further include the steps of directing the user to a webpage and granting access to the webpage using a character string associated with the receiver. Alternatively, the method can also further include the step of receiving a message sent to the receiver containing information relating to the one content element. The unique identifier is a phone number associated with the broadcast source and the receiver is a portable communication device in one embodiment. In one embodiment, the communication device is a USB storage device, a Bluetooth device, a media player or a cellular telephone. The item can include a downloadable version of the one content element. In addition, the item can be grouped on a webpage with additional purchasable items associated with the one content element. In one embodiment, the item and the one content element include, but are not limited to a song, a ringtone, a game, software, a graphic, a concert ticket, an article of clothing, movie tickets, a consumer product, food, a coupon, a rebate, and combinations thereof.

In another aspect the invention relates to a system for exchanging data between a user and a content source. The system includes a transmission device adapted to update and transmit a playout list. In turn, the playout list includes a chronological arrangement of content broadcast by the content source. The system also includes a server adapted to interface with the transmission device and a user's communication device such that the user is directed to the server using a unique content source identifier adapted for use with the communication device and wherein the playout list is accessed to identify content selected by the user. The server further includes content available for purchase by the user and a user specific webpage accessible using a unique user identifier in one embodiment. The content source can include a radio station and the communication device can include a cellular telephone. Also, the unique user identifier can include the user's cellular telephone number or a pre-selected character string. In one embodiment, the unique identifier is a phone number associated with the content source. The communication device can include, but is not limited to a cellular telephone, a personal digital assistant, a media player, a USB drive, and a Personal Computer (PC). In one embodiment, the server is adapted to enable purchase of content selected by the user in response to a broadcast from the content source and to remit compensation to the content source. In another embodiment, the server is adapted to transmit a message to the communication device containing information relating to a portion of the content broadcast by the content source.

In yet another aspect, the invention relates to a method adapted for use on a mobile device, which identifies specific content and a broadcast source. The method includes the steps of executing a program using the mobile device in response to at least one keystroke or voice command, communicating with a database adapted for identifying the specific content using a playout list provided by the broadcast source, communicating with a server adapted for hosting individual user account details, receiving information about a purchasable item associated with the specific content from the server; and remitting compensation to the broadcast source in response to purchase of the item. The item can include, but is not limited to a song, a ringtone, a game, software, a graphic, a concert ticket, an article of clothing, movie tickets, a consumer product, food, a coupon, a rebate, and combinations thereof. The mobile device can include, but is not limited to a cellular telephone, a personal digital assistant, a media player, a USB drive, and a Personal Computer. In one embodiment, the broadcast source is a radio station, an advertiser, or a music aggregator.

In another aspect, the invention relates to a method of targeted advertising. The method includes the steps of broadcasting a chronologically arranged sequence of content to a potential consumer, the sequence broadcast from a unique content source, selecting an element from the sequence by the consumer using a communication device, identifying the selected element using chronologically arranged data corresponding to the chronological arranged sequence of content provided by the unique content source, providing to the consumer a plurality of purchasing options relating to the selected element of the broadcast, and compensating the unique content source if the consumer purchases an item in response to the purchasing options provided. In one embodiment, the method further includes the step of compensating the unique content source if the consumer requests more information about the element. In another embodiment, the element can include, but is not limited to a song, a ringtone, a game, software, a graphic, a concert ticket, an article of clothing, movie tickets, a consumer product, food, a coupon, a rebate, and combinations thereof.

The invention also provides methods, apparatus and systems that extend the scope of various portable electronic devices. These techniques allow a communication device (e.g. mobile phone, personal computer, radio/CD player, DVD player, PDA, media player), to identify a specific media sample. In turn, this enables a purchase from a specific broadcaster and allows each participant in the value chain to a share of the revenue stream, including the broadcaster, the music aggregator, the consumer service provider, the writer and the publisher. Broadcasters of media files, including audio and video, can now operate as retail outlets (e.g. radio stations, TV stations).

In one aspect, the invention relates to a method for compensating a broadcaster for a content purchase using a portable electronic device, such as a mobile phone. The method includes the steps of sampling content originating from one or more sources. Generally, the sources provide audio content, visual content, or combinations thereof. Another part of the method uses a sample of the chosen content to identify a specific media file (or files). Purchasing a downloadable version of the content is an optional step of the method. Compensating a licensed provider of the application software and/or a broadcaster according to a compensation model and licensing arrangement is another step in the method. The broadcaster may be the party that provides the requisite application software either in a branded or unbranded form.

In one embodiment of this aspect, the method further includes the step of downloading and storing the downloadable version of the content within the portable electronic device. In another embodiment, the downloadable version is stored on a secondary device such as a Personal Computer or home entertainment system. In one embodiment, the application for identifying the content, the artist associated with the content and a licensed source of the media file version of the content is sold in combination with a portable electronic device. Once the media file version of the content has been made available to the user, different embodiments of the invention allow the user to download it to their cell phone, PDA, PC or home entertainment system or store it on a central server operated by the application provider. In another embodiment, the downloadable version is stored on a central server that can be accessed at any time. In yet another embodiment, one or more radio stations or other broadcast sources provide the content that is sampled, however in this embodiment; it is the station from whom the user downloaded the software that will be compensated. Therefore, according to this embodiment the broadcaster of the song is not compensated, but the broadcaster providing the application receives compensation.

In another embodiment, the user can specify search criteria via their mobile device for known media files or related merchandise, in order to locate and purchase the item(s). In this embodiment, the software application will identify which broadcaster should be compensated for the purchase. One embodiment of the invention also relates to techniques for sourcing media files. Sourcing implies that a digital media file ordered is obtained from any one of a number of fulfillment companies or on-line databases. In turn, these databases provide the service of delivering media files. Sourcing also contemplates obtaining information or files directly from the copyright holder. If one fulfillment company does not have the required media file, that is if it cannot source the file, then other databases and companies are searched.

Accordingly, the invention allows a broadcaster to become a retailer of media files (e.g. songs, and video's) and related merchandise and services. Thus, the invention provides a method for the user to purchase a media file upon hearing/seeing the desired content through a short, two step process. The first step is to initiate the application and the second step is to confirm the purchase while the application invisibly performs the searching, identifying and sourcing of the media file for the user. This seamless process creates a unique impulse purchase opportunity not currently available. Although music vendors exist, they do not teach the ‘instant purchase’ aspect of the invention. Specifically, although some content identifiers allow for song purchase, a user must execute multiple steps. The seamless impulse purchasing that is designed to compensate value chain members as disclosed herein is distinctly different from this approach.

Further, the invention provides a method for a broadcaster to earn revenue through the sale of media files in a way that has not previously been available in prior art. A broadcaster sharing in the revenue stream is a significant incentive for the broadcaster to advertise, promote and deliver the application to the consumer. Each broadcaster delivering the application will have a unique identifier, hardcode into the application in one embodiment. It will identify the broadcaster for compensation purposes once a purchase is initiated through the application. Because of this unique capability, one aspect of the invention promotes aggressive application sales by a broadcaster in order to secure as many listeners/viewers as possible to load the software application on their mobile device or to acquire a broadcaster specific device.

The more listeners/viewers who use a particular broadcaster's application, the more revenue will accrue to that particular broadcaster each time the listener/user purchases using the broadcaster's software. Ideally, the user will wish to purchase a media file having heard/seen same from the broadcaster from whom the user has installed the software. However, the user and broadcaster are not confined to purchases of content identified on the “installing broadcaster” station/channel. The user may hear/see a media file in a variety of sources and wish to purchase it (through their application or other broadcaster service). Using the “installing broadcaster's” software or service enables the purchase of desired material. As a result the “installing broadcaster” will still receive a portion of the revenue stream. In the prior art, substantially no such mass consumer delivery mechanism exists, nor has there been any method to facilitate the broadcaster compensation as disclosed herein.

Comparing the present invention to those approaches known in the prior art reveals several distinctions. Specifically, there are a number of itemised points that are features of the invention that are not known in the prior art. First, the broadcaster is compensated for the sale of each media file. Second, the user can use a device (e.g. Cell phone) to identify a media file and then purchase that media file using their device with only one or more key strokes. Third, registration of the application and the user's information allows a consumer to benefit by using a device (e.g. Cell phone) to search for a media file and then use the same device to purchase the media file. Finally, the user of the inventive approach can use a device to recognize or search for a video media file and purchase it using their device while at the same time compensating a broadcaster who may, or may not, have broadcast that particular media file.

It should be understood that the terms “a,” “an,” and “the” mean “one or more,” unless expressly specified otherwise.

The foregoing, and other features and advantages of the invention, as well as the invention itself, will be more fully understood from the description, drawings, and claims which follow.

### BRIEF DESCRIPTION OF THE DRAWINGS

Reference to the figures herein is intended to provide a better understanding of the methods and apparatus of the invention but are not intended to limit the scope of the invention to the specifically depicted embodiments. The drawings are not necessarily to scale, emphasis instead being placed upon illustrating the principles of the invention. Like reference characters in the respective figures typically indicate corresponding parts.

FIG. 1 is a block diagram depicting portions of a compensation system adapted to enrich broadcasters and advertisers by generating new revenue in accordance with an illustrative embodiment of the invention.

FIG. 2 is a block diagram depicting an arrangement of devices and hardware components suitable for implementing a compensation system according to an illustrative embodiment of the invention.

FIG. 3 is a block diagram depicting different examples of content element broadcasts suitable for implementing the methods and system of the invention.

FIGS. 4A-4B are flowcharts depicting methods of the invention wherein a broadcaster provides a user with a broadcaster specific phone number to access a consumer interface system according to an illustrative embodiment of the invention.

FIG. 5 is a flowchart depicting an embodiment of a system wherein the broadcaster provides a website address or URL wherein the users can register their contact and payment details.

FIG. 6 is a flowchart depicting methods of the invention wherein the operation of the method is independent of the entity supplying the content heard or seen by a user according to an illustrative embodiment of the invention.

FIG. 7 is a flowchart depicting broadcast source compensation models that use a media player and other devices to select content of interest according to an illustrative embodiment of the invention.

FIG. 8 is a flowchart depicting an embodiment of a method wherein a broadcaster provides a user with a broadcaster specific application and the user registers via the cell phone.

FIG. 9 is a flowchart depicting an embodiment of a method wherein a broadcaster provided software application is used in conjunction with a communication device according to an illustrative embodiment of the invention.

FIG. 10A-10B are flowcharts depicting embodiments of a method wherein a central database containing licensing, ownership and/or compensation information is accessed according to an illustrative embodiment of the invention.

FIG. 11 is a block diagram of an embodiment of a system for identifying audio and visual content with a view to purchasing same, by using a broadcaster specific application installed on a communication device.

FIG. 12 is a block diagram depicting two different options for resolving transactions relating to the legal rights involved in content purchases according to an illustrative embodiment of the invention.

The claimed invention will be more completely understood through the following detailed description, which should be read in conjunction with the attached drawings. In this description, like numbers refer to similar elements within various embodiments of the present invention.

### DETAILED DESCRIPTION

The following description refers to the accompanying drawings that illustrate certain embodiments of the present invention. Other embodiments are possible and modifications may be made to the embodiments without departing from the spirit and scope of the invention. Therefore, the following detailed description is not meant to limit the present invention. Rather, the scope of the present invention is defined by the appended claims.

It should be understood that the order of the steps of the methods of the invention is immaterial so long as the invention remains operable. Moreover, two or more steps may be conducted simultaneously or in a different order than recited herein unless otherwise specified.

In part, the claimed invention provides methods and systems for compensating broadcast sources (broadcasters) and advertisers partnered with a broadcast source. The overall objective of the different aspects and embodiments disclosed herein is to offer compensation schemes that that generate revenue for broadcasters, advertisers, music aggregators, licensing bodies and/or their affiliate partners and service providers. In particular, it is the object of the invention to provide new revenue opportunities in combination with existing business models relating to content delivery and targeted advertising. Additional details relating to these features of the invention may be understood in greater detail in relation to the enclosed figures and claims.

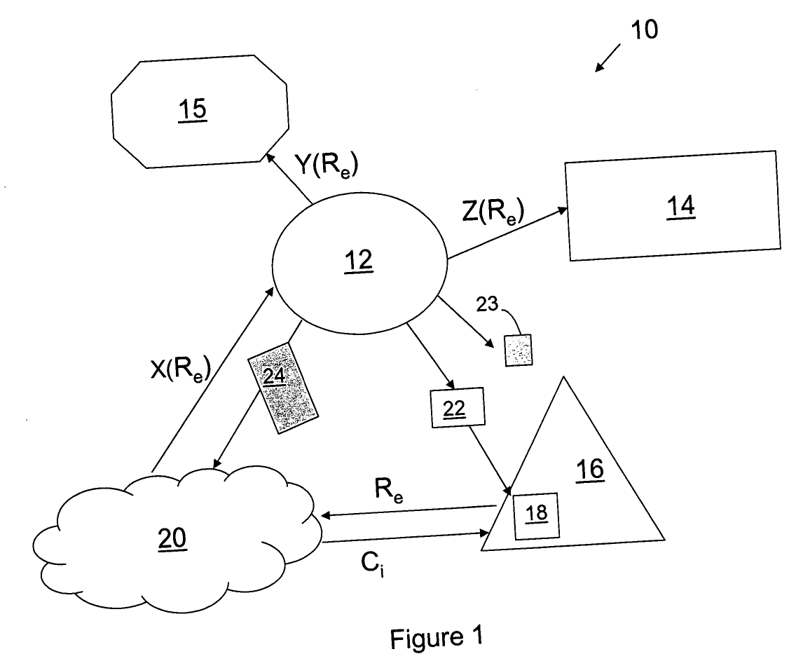

FIG. 1 is a block diagram depicting a portion of a compensation system 10 adapted to generate revenue for a broadcaster 12. Additionally, in some implementations, a music aggregator service 14 and an advertiser 15, either alone, or in combination with the broadcaster 12 also receive compensation. The different entities and service providers shown in FIG. 1 interact, either directly or indirectly, with a user or potential consumer 16. The potential consumer 16 typically uses a communication device 18 to interact with a customer interaction/content delivery system 20 alone or in combination with other components of the overall system 10. In order to understand the customer's interaction with other system components in more detail, an exemplary purchasing is informative.

In an exemplary purchasing event, a user 16 initial hears or sees a broadcast from a broadcast source 12 such as a radio or television station. Typically, the broadcast includes content elements 22 (audio and/or video content) that are of interest to listeners or viewers. For example, suitable broadcast content elements can include, but are not limited to songs, advertisements, programs, movies, television shows and other information. The content elements that are present in a particular broadcast interval can be arranged in a particular sequence as a function of their individual broadcast times.

As shown in exemplary system of FIG. 1, a sequence of content elements 22 is broadcast from the broadcast source 12. Upon hearing the broadcast content 22, the user 16 may like a particular song or be interested in hearing more about a concert ticket advertisement that are being broadcast. In response to hearing a content element of interest, the user activates a communication device or receiver 18 to obtain information and purchasing options that relate to the selected content element. Specifically, in one embodiment, as part of the information being broadcast 22, a unique identifier 23 such a phone number associated with the radio station or the radio station call letters (such as for example: 99.1 or WXYZ) are broadcast from the source 12. Instructions and options associated with using the unique identifier 23 in conjunction with a communication device 18 are also broadcast or otherwise presented to the user 16. In turn, the user can activate the communication device 18 and use it in conjunction with the unique identifier 23 to contact the consumer service 20. A business arrangement typically exists between the consumer service 20 and the broadcast source 12. The first action that the consumer service 20 typically takes is to identify the particular song or other content element of interest to the user 16. In some embodiments, the consumer service 20 supports multiple radio stations and individual radio stations are differentiated based on user inputs, such as the radio station call letters or other broadcast source specific identifiers.

As part of the content identification process, the broadcast source 12 generates a playout list 24 that tracks the information being broadcast as a function of time. The playout list 24 is typically maintained by the broadcaster and is suitable for hosting on a server, transmission device or other data storage device. The playout list 24 is also transmitted to the customer interaction/content delivery system 20. Since the consumer 16 uses the unique identifier 23 in conjunction with the communication device 18 to access the customer interaction/content delivery system 20 when the consumer hears the content element of interest, the playout list 24 can be correlated with the time the customer interaction/content delivery system 20 is contacted by the user 16 to identify the content element of interest. In some embodiments the customer interaction/content delivery system is entirely automated, while in other embodiments it incorporates a human operator and hardware components. In other embodiments, the customer only receives a voicemail, email, text message, or other message informing them of the website URL where they can access additional information and buy the content of interest and items associated with it. Examples of items that can be advertised, or offered for purchase in response to a potential consumer's interest in some content element of interest include, but are not limited to a song, a ringtone, a game, media, magazines, services, software, a graphic, a concert ticket, an article of clothing, movie tickets, event tickets, passes, invitations, a consumer product, food, a coupon, a rebate, and combinations thereof.

In an exemplary embodiment, upon contacting the service 20 when a content element of interest, such a new song, is being broadcast, the user is informed of the identity of the content of interest, i.e. the name of the song or more information about what they were listening to when the activated their communication device 18 using the unique identifier. In one embodiment, the user is given the option of having a representative of the service 20 contact them directly to provide additional details. In another embodiment, the user is given the option of purchasing a downloadable version of the content of interest Cᵢ through the communication device, a webpage, or an Internet or network based mechanism. However, it is noteworthy that the content of interest could be an advertisement for theater tickets or for an open house for a new home. Thus, when a user activates their communication device and is connected to the service they may connect directly with an operator, receive a menu on their communication device, receive a text message directing them to a webpage, have an electronic wish list updated with the particular content of interest, receive an automated voice message identifying the content of interest and/or other options and information.

Moreover, if a potential customer 16 is connected to the service 20 via their communication device or directed to webpage operated by the service 20, their range of purchasing options is not limited to only the content element of interest, but rather any items and services associated with the content. Thus, if a user hears a particular song and is directed to a webpage, additional items such as clothing items relating to the band that performs the song, concert tickets for the band, or other artists that are enjoyed by other listeners that have historically been interested in song that caused the user to initially connect to the service are available for review and/or purchase. As a result of accessing the service 20, the user may elect to purchase one or more items or participate in surveys or otherwise access advertising that is valuable to an ad agency. Accordingly, anyone of these events results in an income producing event with an associated revenue event Rₑ. Given the flexibility of the automated and semi-automated embodiments described herein, it is clear that the potential for revenue to exceed expenses is significant. Furthermore, by enabling instant purchases of a range of goods and services, broadcasters are able to access revenue streams that would other go untapped or capitalized upon by other vendors. For at least these reasons, the techniques disclosed herein offer significant advantages over existing broadcast source compensation models.

The partitioning and allocation of costs and profits among participants in the overall system will vary by market and the individual business relationships. For example, as part of the system 10, the broadcast source 12 receives a percentage of the purchase price/revenue X(Rₑ), wherein X ranges from 0 to 100%, associated with a transaction involving the content of interest Cᵢ. Similarly, if the broadcast source is partnered with an advertising agency 15 and/or a music aggregator/music vendor service 14, the other parties involved may also receive a percentage of the revenue Y(Rₑ) and Z(Rₑ), respectively. Thus, Y and Z also can range from 0 to 100%. Thus, if the broadcast source was a radio station and it was selling t-shirts for the station, X=100%, Y=0, and Z=0. However, if the content of interest is a download for a song, and an advertiser 15 is not involved an X=50%, Z=50%, Y=0 split, or other allocation, may be possible. In most compensation arrangements, the consumer service 20 may also offer its services to the broadcast source for a fixed fee contract or as a percentage of the sales and advertising revenue resulting from use of the overall system 10.

Other compensation schemes wherein the broadcast source receives money from the advertiser for providing targeted advertising and purchasing options to a potential consumer are also within the scope of the invention. As the potential consumer actively solicits information by activating a communication device, as opposed to the traditional model of passive listening, this form of targeted advertising may be worth a premium in certain demographic markets. In addition, given the opportunity to generate impulse purchases for songs and other content elements of interest, enhanced revenue generation is possible. In addition to the approach described in FIG. 1, other systems and methods can be used to implement the broader ideas disclosed herein.

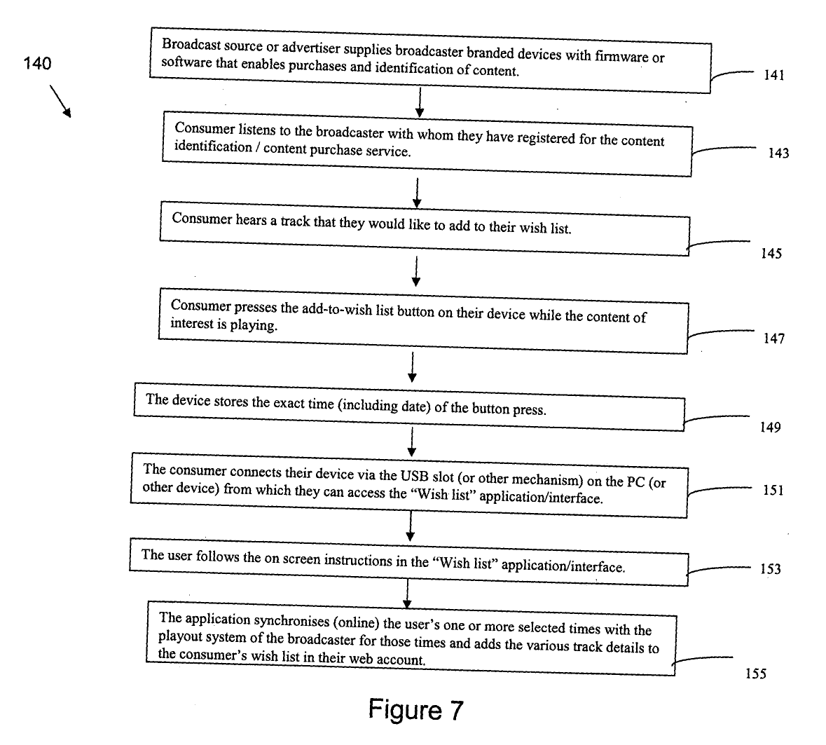

Alternatively, in another compensation system for broadcasters, a communication device or receiver is sold or provided by the radio station. This broadcaster specific device contains a program or firmware that allows for identification of the content element of interest and/or direct communication with the broadcast source or the customer interaction/content delivery system. In this implementation, the communication device is typically a media player such as an MP3 player or other digital format player with a mechanism (e.g. USB, Bluetooth) for connecting to a computer for content downloads/purchases. However, other devices such as cell phones can be adapted using software applications and other software capable of one-click purchases and connections as known in the art. Further details of some exemplary embodiments are described below in relation to FIG. 7. In one embodiment, the application is based on midlet, applet, java or other suitable programming and development tools.

In one embodiment, the communication device is responsive to one or more keystrokes such that when a particular content element of interest is broadcast, the relevant keystroke(s) saves temporal data that corresponds to when the relevant content element was broadcast from the source that provided the communication device. The firmware within the device is associated with a particular broadcast source and adapted to save time indices corresponding to when content elements of interest are flagged by a potential consumer using their device. When the device is connected to an online computer, such as for example via a USB port or Bluetooth, the application on the computer or the device can use the time indices to identify the relevant content of interest by communicating with a server containing playout list data. Once identified, the content of interest can be listed on a wish list on the device or on a webpage associated with the user. The webpage can include a digital locker to store a user's electronic purchases, wish list items and other related information.

In one embodiment, the implementation offered to a consumer can include features specific to programs that are repeatedly broadcast from a particular source, such as for example a news program, a sports program, or a particular talk show. Thus, if a consumer is listening to a particular program, such as a sports talk show, activating the device at the time of broadcast will add the program to their wish list for later download/purchase. However, as part of the process, the consumer may be given the option to record the program each time it is broadcast. Thus, the device can be used to initiate subscriptions to particular repeat shows. This type of purchasing event is of interest to both advertisers and the originating broadcast sources. As some broadcast sources originate their own talk, news, and sports programming, offering these programs for purchase can result in enhanced revenue generation.

In addition, the webpage can provided targeted ads relating to the content of interest or historic content of interest previously solicited by the user. Alternatively, once a connection to an online computer has been achieved and the identification process is complete the device can be configured to automatically offer the user the ability to purchase the content of interest and download the digital music to the device for immediate enjoyment. Thus, impulse purchases and instantly responsive targeted advertising can be accounted for and compensation generating transactions properly charged. As a result, the broadcast source that supplied the device and the partnered affiliates reap the benefits of previously unavailable sales and service transactions.

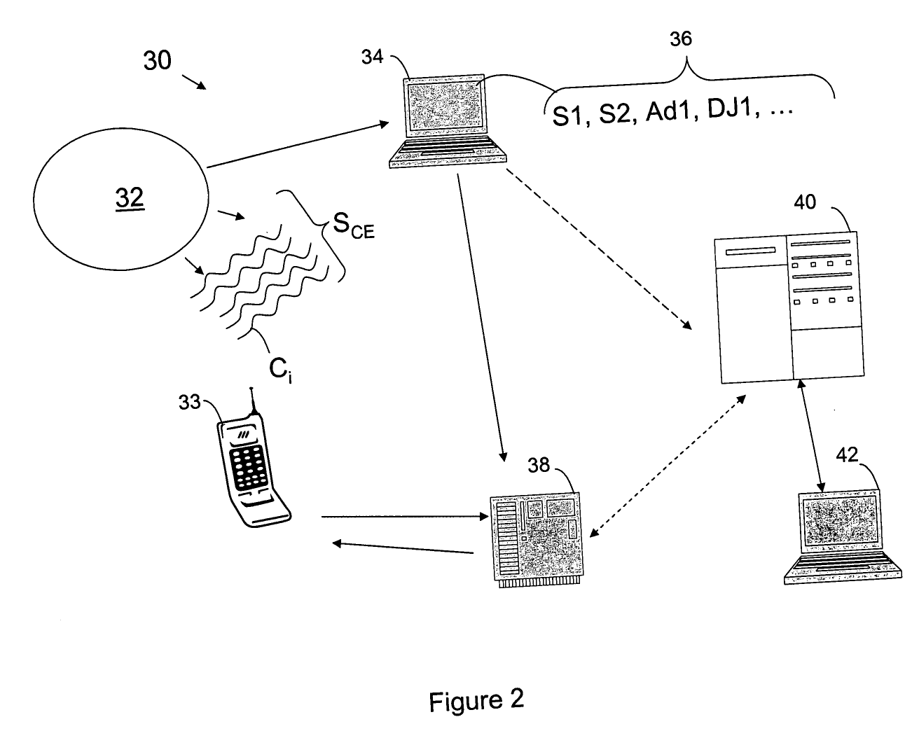

As aspects of different broadcast source and advertiser compensation schemes have been described at a general level, it is informative to consider some of the technical details of exemplary implementations of these approaches. An exemplary arrangement of components suitable for implementing the system 10 described in FIG. 1 is depicted in the data exchange system 30 shown in FIG. 2. As part of the system 30 depicted, a broadcast source 32 is shown broadcasting a sequence of content elements S_{CE}, including some content of interest Cᵢ. A user (not shown) operates a receiver/communication device 33 that is activated when the content of interest Cᵢ is heard or seen by the user. The communication device 33, can include, but is not limited to a media player, a cellular telephone, a personal computer, a personal digital assistant, and other electronic devices as known to those in the art. The broadcast source 32 uses a transmission device 34 to generate and/or maintain a playout list 36 that identifies the sequence of content elements S_{CE} as a function of content broadcast order or as a function of what is playing at specific time intervals.

Accordingly, an exemplary playout list 36 may include Song_, Song_2, Advertisement_1, Radio Station Promo_1, DJ Comment_1, Song_3, Radio Station Promo_2, and so on. In addition, the playout list 36 may also include time interval data corresponding to each content element along with supplemental data. Thus, if the DJ Comment_1 makes mention of a radio station party event, in addition to the time indices corresponding to when the promo was played, the playout list data may also include information about the business relationship with advertisers and music aggregators when the playout list is transmitted. In addition, when the playout list is processed for content element identification purposes if Song_2 is played at time interval two, and time interval two was when a user activated the communication device, content elements played during time interval one and time interval three may also be selected for user review, delivery of additional information and for purchase consideration. Providing content elements on either side of the content element of interest helps ensure goodness of fit based on the user's selection when a playout list based content identifying system. It also allows for additional advertising options.

Alternatively, the playout list 36 can be recorded by another entity or device that does not incorporate transmission functionality. Typically, the playout list 36 is generated and/or stored on the transmission device 34, such as a computer server. The transmission device 34 is adapted to send portions of the playout list 36 to a service or a device that will identify the content of interest and present informational or purchasing options to a potential consumer.

Thus, as shown in FIG. 2, a communication server 38 operated by the company or service that is offering the methods and systems disclosed herein to a broadcast source is shown. The communication server 38 is used to communicate with the user using automated means, such as user directed messages, emails, website URLs, etc. Alternatively, the communication server 38 can offer access to a human operator or an interactive voice response service. In one embodiment, the communication server 38 receives the playout list data 36 in order to identify the content of interest Cᵢ and thereby properly direct the user and compensate the appropriate parties. The communication server 38 may maintain any webpage relevant to the content of interest that the user is directed to and/or the server may contain downloadable versions of the content of interest, such as songs or ringtones.

Alternatively, the communication server 38 may operate solely as a communication interface with the user for the purposes of sending website URLs, maintaining user database information, registering users, scheduling sales personnel to contact the user or delivering electronic documents or other text based information to the user. In such an implementation, a processing server 40 is used to contain the webpage data, user registration, databases, digital lockers, webpage wish lists, customer purchase information, advertisements, downloadable songs, and other information and data as appropriate. In one embodiment, the processing server 40 is connected to third party providers of content, such as downloadable music and ringtones, and related information, such as identification information and licensing information. Thus, when a user interacts with the communication server 38, they receive information that typically includes a webpage address that is resident on the processing server 40 that the user can access using the communication device or a terminal/personal computer 42. As shown, by the dotted lines in FIG. 2, some of the data transmission connections are optional. The playout list may be used in some implementations of the processing sever 40, while in another embodiments the content element of interest step is only carried out by the communication server 38. Although the system 30 components 34, 38, and 40 are shown as separate devices in some embodiments these functions may be performed by a single server that interacts with the user, provides the content of interest, and maintains the playout list.

Returning to FIG. 2, once the user of the communication device is exposed to content from a particular broadcast source 32 the potential consumer activates their communication device 33 using a unique identifier associated with the broadcast source 32. In one embodiment, the unique identifier is a phone number associated with the particular broadcast source 32. In another embodiment, the unique identifier is a character string or other identifier that can be associated with any company in lieu of a specific broadcast source 32. Thus, if a company offers the service of selling content merchandise or processing consumer responses to advertisements broadcast from a variety of broadcast sources, the unique identifier is paired with a URL or phone number associated with the company providing the overall service, rather than each broadcast source 32.

Upon accessing the company via the identifier, supplemental identifier information, such as the broadcaster's name or call letters, is combined with all of the playout list data that the service providing company controls. The entire pool of playout list data can be assembled from all of the broadcast sources partnered with the company to enable content identification and sales services. Using the supplemental identifier data can be used to tailor the content delivered to the user. Alternatively, all of the content being broadcast at the time of the activation of the device can be sent to the user for further review with associated purchasing and information delivery options.

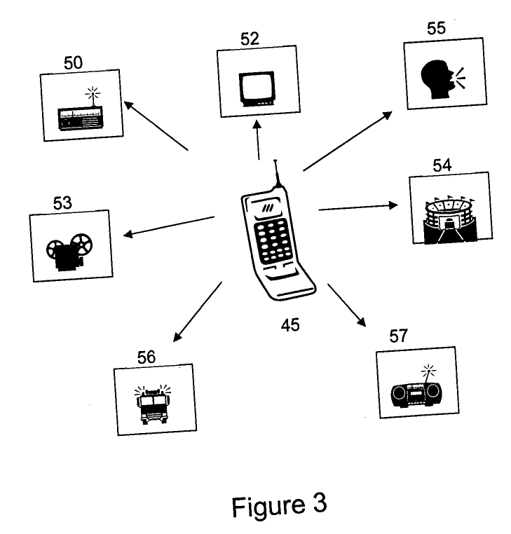

FIG. 3 depicts a variety of locations or events wherein different content elements and purchasing opportunities can be accessed using a receiver 45, although depicted as a cellular telephone the receiver can be human being or a suitable communication device, in combination with the system, device and method embodiments of the invention discussed herein. A radio playing music content 50 which can be identified using a sample of the music or the playout list matching system described above is shown as a typical source of broadcast content. Similarly, a television broadcast 52 which broadcasts music or other audio or audio-visual material from which a consumer can use a communication device in combination with a unique broadcast identifier displayed on the television and then have that content identified while having the option of purchasing it.

Furthermore, a movie broadcast at a cinema 53 that sells tickets and merchandise also functions as a broadcast source suitable for use with the techniques disclosed herein. As such, the cinema or its parent company can maintain a playout list of movie times and advertise a unique identifier associated with the cinema or parent company that can be used with a communication device as discussed above. Similarly, a concert venue 54 or the entertainment label sponsoring a particular artist's concert can function as broadcast for live performances hosted by the venue or produced by the label. Activation of a communication device when particular songs are playing can be used to enable instant purchases of the music using some of the systems and methods discussed above. A club broadcast 55 shows music being broadcast at a discotheque. Thus, specific night clubs can sponsor music purchase events using the techniques disclosed herein. Broadcast from motor vehicle radio or other media player relaying music 56 offer compensation events for radio station and the suppliers of media players. In some embodiments, the receiver 45 is a mobile device capable of reproducing media files such as ringtones, ringback tones, MP3s and may also be equipped with a radio receiver. A home entertainment system 57 can be used as a broadcast source or as a delivery location for music or other content purchased using the techniques disclosed herein.

Still referring to FIG. 3, in addition to serving as conduits for broadcast sources or the sources themselves, the illustrative locations and scenarios depicted in the figure may be configured to broadcast encoded information that can be wirelessly processed by a communication device or receiver 45. This can be achieved by incorporating Bluetooth devices that can interact with a receiver in different locations. Thus, as many cellular phones and other devices are Bluetooth compatible, specific instructions and information in the form of wireless data be sent to a particular communication device. Thus, if a user is present at one of the venues or locales shown in FIG. 3 that contains a Bluetooth transmitter, purchasing options relating to the particular content that is being broadcast can be beamed directly to the user's phone. Thus, someone can be listening to music at a club 55 equipped with a Bluetooth or other transmission device that beams information about a particular broadcast source and a unique identifier associated with that source. For example, a cell phone user with a receiver 45 may get a message or Bluetooth signal that instructs them if they like any song they hear tonight to dial a certain number when they hear that song. Playout list synchronization can be used with the time of the call to enable the identification of the content. Since the Bluetooth or other transmitter of the initial information is owned or associated with the club and any broadcast partner, revenue generated directly benefits the initial broadcast source/club venue.

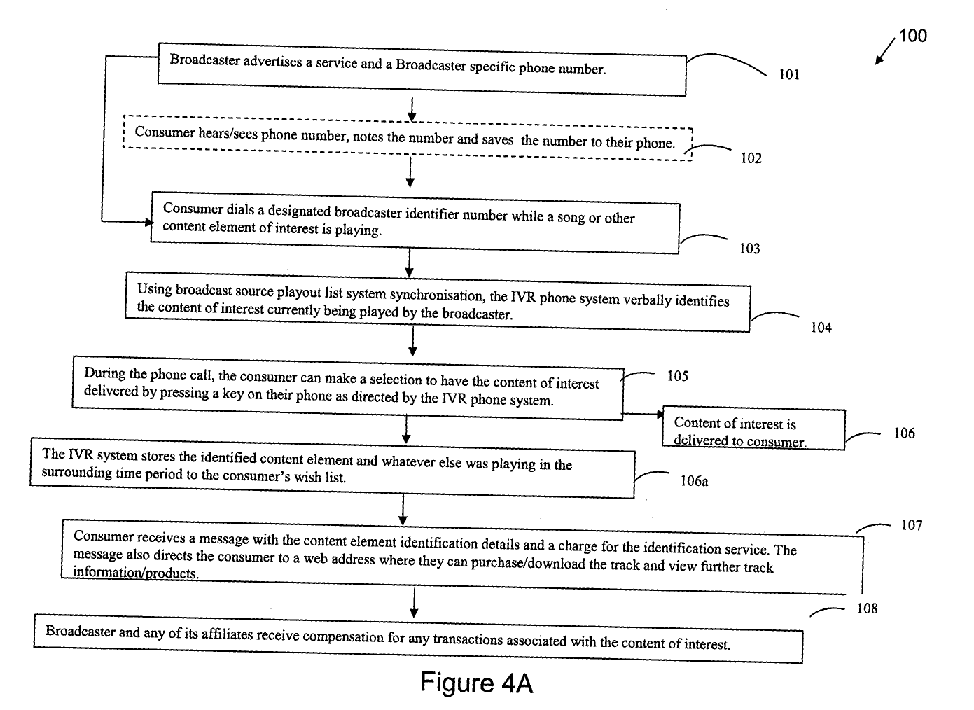

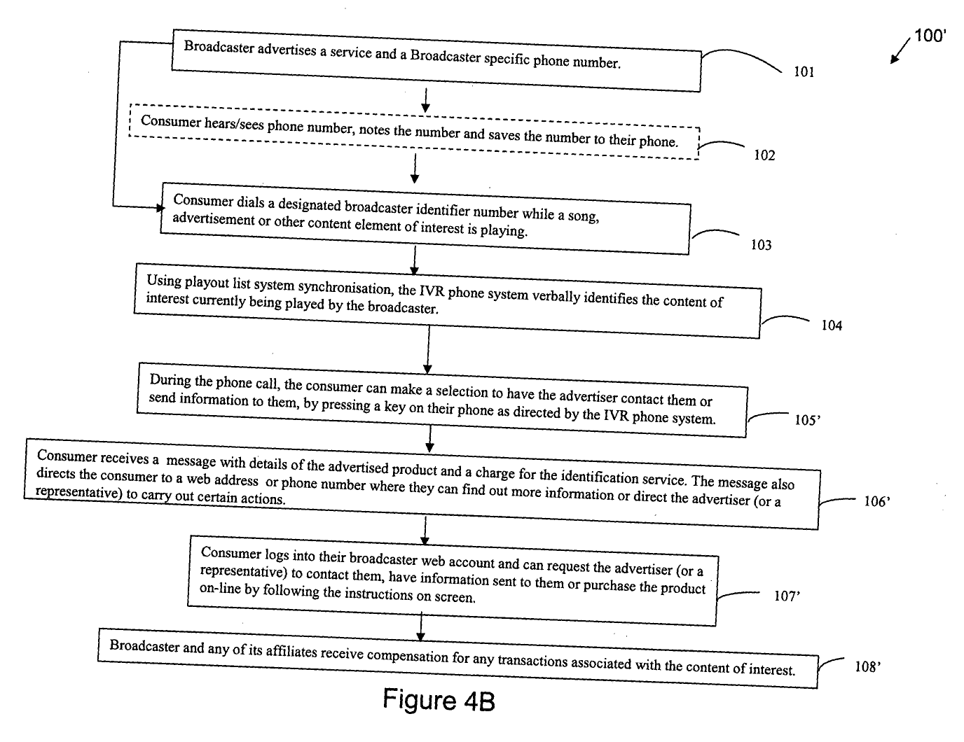

FIG. 4A describes a method 100 for identifying content of interest, such as songs broadcast from a particular source, and for facilitating the purchase of the content of interest and any items or services selectively associated with the song. The method can include an interactive voice response (IVR) system such that portions of the invention are automated. Initially, a broadcaster advertises their targeted content selling service and broadcasts a specific phone number for consumers to dial using a communication device Step 101. This phone number or other suitable broadcaster unique identifier provides the means to identify the content of interest. Optionally, the consumer hears/sees the phone number and saves the phone number to their phone Step 102. If a consumer is listening to a broadcaster of a particular song or content element of interest, the consumer dials the designated broadcaster number while the content of interest is playing Step 103. Using broadcast source playout list system synchronisation, an IVR system and its associated processing components verbally identify the content of interest currently being played by the broadcaster Step 104. During the phone call, the consumer can make a selection to have the content of interest delivered by pressing a key on their phone as directed by the IVR system Step 105. The content of interest can be delivered to the phone, a webpage for later download, a personal computer, mailed to the consumer's place of residence or another suitable location convenient for the consumer Step 106.

The IVR system stores the identified content element and may also store whatever else was playing in the surrounding time period to the consumer's wish list Step 106a. In some embodiments, a wish list is not used, and the act of using the service results in the automatic purchase of the song. The wish list can be electronically stored on a server as part of a personal broadcaster account established for the consumer. In one embodiment, the consumer's own phone number is used as an identifier to access their personal broadcaster operated account. Thus, the consumer is identified by their phone number (caller ID) which is transmitted to the IVR system when the content identification call is initially placed.

In one embodiment, the consumer receives a message, such as an SMS/MMS message, email, voicemail, or combinations thereof with the content identification details and a charge for the identification service. The message also directs the consumer to a web address where they can purchase/download the track and view further track information/products Step 107. As a result, the broadcaster and any of its affiliates receive compensation for any transactions associated with the content of interest Step 108. Thus, as a result of expressing an interest in the content of interest, if the consumer buys additional items from the service that are linked on a webpage or otherwise described by sales personnel additional revenue is generated for the broadcaster Step 108.

The consumer can log into their broadcaster web account and purchase/download the content of interest (and/or related products e.g. album) from their wish list organized by the service supplying the identification and marketing system to the broadcaster. If the consumer already purchased the content by phone, the consumer can download the content to their PC or other devices. Consumers can also delete content from their wish list. Accordingly, in one embodiment the invention relates to a system wherein a broadcaster provides a user with a broadcaster specific phone number and the consumer dials this number to have a currently playing tune, or album, recognized and added to their wish list and receive a text message confirming the transaction.

FIG. 4B depicts an advertisement, identification, and content purchase method 100′ suitable for compensating broadcasters and their affiliates. The method shown in FIG. 4B incorporates the same steps 101 to 104 described above with respect to FIG. 4A. After Step 104, during the phone call, the consumer can make a selection to have the advertiser contact them or send information to them, by pressing a key on their phone as directed by the IVR phone system Step 105′. As a result, the consumer receives a message with details of the advertised product and a charge for the identification service. The text message also directs the consumer to a web address or phone number where they can find out more information or direct the advertiser (or a representative) to carry out certain actions Step 106′. Consumer logs into their broadcaster web account and can request the advertiser (or a representative) to contact them, have information sent to them or purchase the product on-line by following the instructions on screen Step 107′. Finally, the broadcaster and any of its affiliates receive compensation for any transactions associated with the content of interest Step 108′. Accordingly, in one embodiment the invention relates to a system wherein a broadcaster provides a user with a broadcaster specific phone number and the consumer dials this number to have a currently playing advertisement recognized and added to their wish list and receive a text message confirming the transaction. As a result of the identification transaction when the consumer logs on to the broadcaster's web site, the consumer is given different options such as having information sent to them, having a person phone them or ordering the product/service on-line.

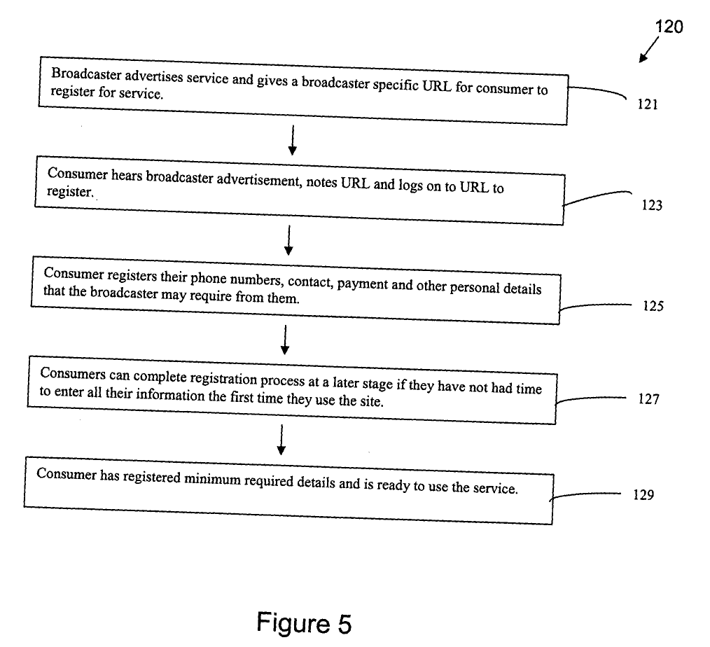

Although in some of the embodiments discussed herein a user may simply use a communication device in concert with a unique identifier provided by a broadcaster to both identify and purchase content, in some embodiments user registration is incorporated as a feature in the overall method. Requiring advance registration provides certain advantages in some embodiments. Specifically, advance registration can require credit card information to reduce the likelihood of future non-payment for services. Additionally, a survey can be incorporated in the registration process to enable enhanced targeted advertising. An exemplary registration method 120 suitable for incorporation in one or more embodiments disclosed herein is depicted in FIG. 5.

In FIG. 5, a broadcaster advertises a consumer service and announces a broadcaster specific URL for consumer's to register for the service Step 121. Initially, a consumer hears the broadcaster advertisement, notes the URL and logs on to a URL to register Step 123. In addition, the consumer registers their phone number(s), contact, payment and other personal details for storage in a secure private database maintained by the service provider Step 125. Consumers can complete registration process at a later stage if they have not had time to enter all their information the first time they use the website sponsored by the broadcaster for content downloads, merchandising and targeted ads Step 127. If the consumer has registered the minimum required details, they are validated to use the service Step 129.

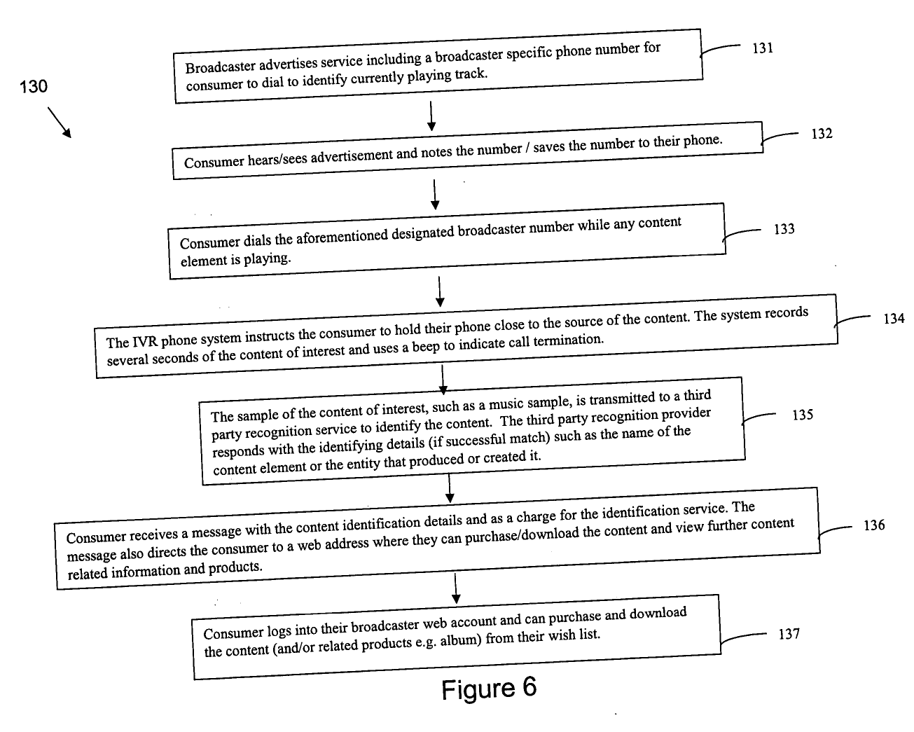

A generalized method 130 for compensating broadcasters for content sales and content identification processes, independent of whether the broadcaster is the source of the content of interest first seen or heard by a potential consumer, is depicted in FIG. 6. Initially, a broadcaster advertises their targeted content identification/retailing service and broadcasts a specific phone number for consumers to dial using a communication device Step 131. This phone number or other suitable broadcaster unique identifier provides the means to identify the content of interest. Optionally, the consumer hears/sees phone number and saves the phone number to their phone Step 132. Consumer is listening to any source of content and wishes to identify a particular content element. The Consumer dials the aforementioned designated broadcaster number while any content element is playing Step 133.

The IVR system instructs the consumer to hold their phone close to the source of the content. The system records several seconds of the content of interest and uses a beep to indicate call termination Step 134. The sample of the content of interest, typically a music sample, is transmitted to a content recognition service to identify the content. The third party recognition provider responds with the identifying details (if successful match) such as the name of the content element or the entity (e.g. artist) that produced or created it Step 135. These identifying details are added to the consumer's wish list. The consumer was identified by using their phone number as a unique identifier through caller ID. In addition, the consumer receives a message with the content of interest identification details and a charge for the identification service. The message also directs the consumer to a web address where they can purchase/download the relevant content and view further content related information/products Step 136. The consumer can log into their broadcaster web account and purchase and download the content (and/or related products e.g. album) from their wish list Step 137.

As described above a media player such as an MP3 player or other communication device such as a cellular telephone or a USB storage device can be given away or sold by a particular broadcast source as a step in revenue generating method. Additional details relating to embodiments of this approach are describes in FIG. 7.

FIG. 7 describes a method 140 wherein a broadcast source supplies broadcaster branded devices to potential consumers. These devices can include a radio tuner, a media player such as those that incorporate a radio tuner, an MP3 player, USB device and other devices suitable for playing digital content and storing information. These devices can include pre-installed firmware or other programs that incorporate functionality that directs any content identification or purchase transactions to services partnered with the source that supplied the device. As such, the initial step in the method is for a broadcast source to supply broadcaster branded devices with firmware or software that controls revenue events from purchases and content identification made using the device, such that any transactions, conducted using the device only generate revenue for the broadcast sources and its partners Step 141.

The devices sold or given to consumers as promotional items can include an add to wish list feature. The wish list includes songs that a consumer may be interested in purchasing. The act of selecting a content element of interest can result in that content element being added to a wish list and ultimately purchased. The wish list can be maintained on the media player, a website and/or a personal computer that includes suitable media player software. The media player software can be a specific wish list selector player provided by the broadcast source, advertiser, or other partnered entity that initially supplied the media players in Step 141.

As part of the method, the consumer listens to the broadcaster with whom they have registered for the service Step 143. While listening, the consumer hears a content element that they would like to add to their wish list and/or purchase Step 145. Consumer presses the add-to-wish list button on their media player or other supplied device while the content element is playing Step 147. The media player or device stores the exact time (including date) of playout time for the content of interest in response to the button press Step 149. The consumer connects their device via the USB slot (or other mechanism) on the PC (or other device) from which they can access the “Wish list” application/interface. Step 151. The wish list can include information displayed on a communication device as a list itemizing content of interest. Typically, the wish list is a web page or other interactive presentation of information that can be accessed from a multitude of devices (e.g. phone, PC) that lists content elements selected by a user or items that relate to content elements selected by the user. The listed elements and items may have already been purchased or be available for future purchase.

Alternatively the application may reside on the device with the “add to wish list” functionality. The user follows the on screen instructions in the “Wish list selector player” application/interface Step 153. The application synchronises (online) and transmits the user's selected playout time data with the playout system of the broadcaster for the relevant times when content of interest was playing. The various content of interest details are then added to the consumer's wish list in their web account Step 155 or, depending on user settings, may be immediately delivered and charged to the consumer. As a result, if the user buys any of the content of interest, the broadcast source that supplied the device receives the revenue. In some embodiments, in lieu of a media player, a branded USB device such as USB drive key ring with an activation button and firmware is provided by the broadcast sources. In another embodiment a Bluetooth enabled device may be provided. These devices can be used in accordance with the method described in FIG. 7 such that pressing the activation button stores time and date information that can be correlated with playout list data at a later time in order to update a wish list or directly purchase songs.

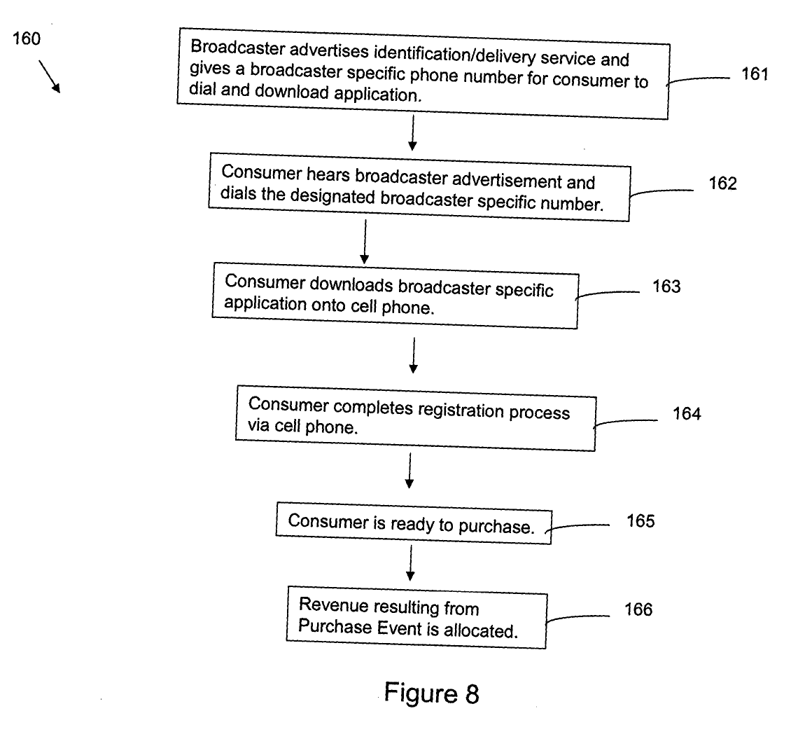

The aspects of the invention also include additional embodiments that incorporate content identification software and devices. In particular, FIG. 8 depicts a compensation method 160 embodiment wherein a broadcaster provides a user with a broadcaster specific application which enables the user to purchase content. Specifically, FIG. 8 depicts a method 160 whereby a broadcaster, such as a radio station or a television channel, advertises the availability to purchase music or video material by simply downloading the broadcaster's software application Step 161 for execution on a device such as a phone or media player. The user will preferably have available a cell phone and will be able to download the broadcaster's application by simply dialing the advertised broadcaster's download number e.g.; 3456 102 Step 162. Upon dialing the designated advertised broadcaster number, the user will automatically download the broadcaster's application onto their cell phone Step 163. The user will then be prompted to register personal details to include name, address and preferred method of payment to include a payment card number. The user may complete the registration on their cell phone Step 164. Once registration has been completed, the user is now ready to purchase or identify audio/audio visual media files Step 165. As a result, any transactions that result from using the downloaded application generate revenue for the broadcast source that supplied the application step 166. The methods described herein provide various options, such as direct download or viral distribution, whereby a user can download a broadcaster specific application onto their cell phone. Other application distribution systems known now or possible in the future are also suitable for use with the approaches disclosed herein.

The broadcast source specific software application described with respect to FIG. 8 can be written in JAVA or other suitable languages and is downloaded to a communication device OTA (over the air) or transferred from another device wirelessly or installed by operator/manufacturer. It can be stored either on the SIM card or mobile device itself. The software application may be initiated by keying in one or more keystrokes from idle state in order to activate the processes and techniques discussed above. Furthermore, the software can be initiated through the selection of a menu option on the mobile phone. The software application can be designed to transfer itself to another communication device at the original or secondary user's instruction and on acceptance by second user, i.e. viral peer-to-peer distribution.

Delivered content can be stored on a cell phone and/or transferred to another device, such as a media player. The file formats of the content will be in accordance with the user defined preferences established at registration e.g. ringtone, MP3, MP4, Atrac, Windows Media file. A further embodiment allows such files to be stored directly on the mobile device as both mobile phones and media players converge to form one device. Users will also be able, according to licensing arrangements entered into with content providers, to download files to their PC or home entertainment centres. Additional memory, file compression techniques, and streaming technology may be used to store the files on the communication device directly in some embodiments.

In one embodiment, each time a user purchases a media file using that particular broadcaster's specific software, the broadcaster, of audio and/or visual media files (e.g. radio stations, television stations), will obtain a commission/margin from each media file purchased through their particular uniquely branded software/device. The payment will be collected from the consumer according to their preferred payment method (e.g. credit card, debit card, phone bill, Premium SMS). From the monies collected, sales and any local taxes applicable will be deducted and the remaining sum will be distributed according to licensing arrangements and revenue share agreements in place with content owners, licensors and broadcasters.

In another embodiment, the broadcaster specific application is installed on the communication device at the point of manufacture. Thus, when the user acquires the device, information about using the content identification and purchase application is bundled with the device. Furthermore, the device may contain electronic or traditional branding relating to the broadcast source supplying or selling the application.

Once the user has installed the application, typically keystroke or voice controlled, a user will be given the opportunity to register their details and preferences to facilitate future purchase of media files. The user details will include, but will not be solely restricted to the following:
1. Personal details—name, address, age, status,
2. Preferred method of delivery and format of audio or audio visual file—e.g. mobile phone (ringtone), portable music player(MP3), Personal Computer(WMA),
3. Details of preferred method of payment—e.g. PSMS, phone bill, smart card, credit card

In one embodiment, upon registration, the central website will create an electronic personal website/locker/storage area for media files purchased, broadcaster branded and specific, for the user. The personalized broadcaster website will offer a number of services to the user, to include, but not solely restricted to the following:
1. Storage/locker facility for purchased media files
2. Links to related information relevant to products purchased
3. Facility to purchase related products (e.g. having purchased a particular song, user will be able to purchase the album)
4. Facility to compile media files into personal albums and collections
5. Facilitate the purchase of compiled/single audio files in CD form.
6. Facilitate the broadcaster to promote, sell and market related products (e.g.; concert tickets, artist merchandise)
7. A valuable data base/consumer profile for the broadcaster.

In yet another embodiment relating to the application based approach described in FIG. 8, a method or system whereby the user is made aware of a particular broadcaster's application through advertising, publicity, from word of mouth and/or some other source is within the scope of the invention. In this embodiment, the user knows a person who has already installed the particular broadcaster application onto their cell phone by any of the methods described above with respect to FIG. 8. By means of using already existing viral peer-to-peer delivery technology, the user can download a broadcaster's application to their device (e.g. cell phone) from another person's device with the broadcaster's application already installed. Once downloaded onto the user's device, registration is then completed.

An example of how the invention described in FIG. 8 works in practice can be seen by a group of friends at a party. Upon hearing a song that a member of the group likes, that individual might desire a permanent copy for their own use. In some embodiments, this is an impulse purchase. This individual, who has already downloaded the application from a broadcaster, would press a specified keystroke sequence, such as #6, to capture a sample from the sound source i.e. the entertainment system at the party. The user would be instructed to record up to 30 seconds of the sample. The phone or other device would send this file sample via the #6 web-site to a licensed music recognition service or open a link whereby the sound is directly recorded on a music recognition server through an open online or phone connection. Once the file sample is identified, a response from the database and/or website is sent to the user. The user can then preview/purchase the content if desired.

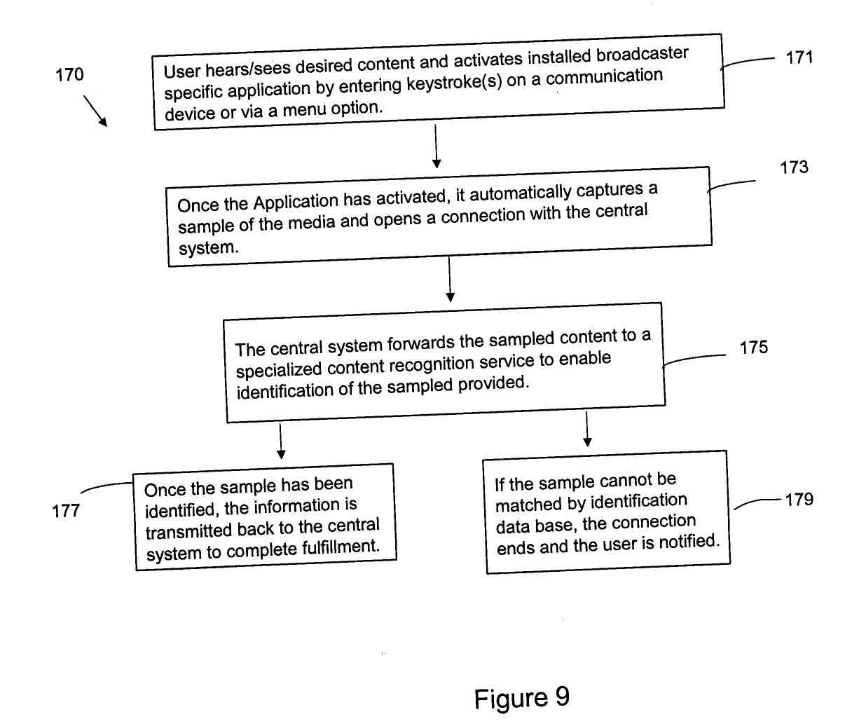

FIG. 9 depicts a process 170 whereby the user activates the installed broadcaster provided application and a desired song/video is sought for purchase. When a user hears/sees the desired content, the user activates the broadcaster's application on their communication device/receiver by keying a specified keystroke sequence on a communication device, such as #6 Step 171. The user then points the communication device at the source of desired content so a sample of the content can be obtained Step 173. Once the broadcast source supplied software application has been activated by the user, a communication channel, such as a cell phone connection, is opened and a sample of the desired content is captured by the central system or channeled directly to the content recognition company Step 175. In one embodiment, the sample length required to complete the process should only take a number of seconds. Once the central database has obtained the requisite media file sample, it forwards the sample to one, or several specialized media recognition database companies for identification purposes. At this stage in the process, there are two possible outcomes, (i) the sample is identified against an identical match Step 177 or, (ii) no identical match can be found within the data base Step 179. If a match has been located, the details pertinent to the identified media sample are forwarded by the media recognition database company to the central database and the process proceeds to fulfillment with the customer being charged and revenue being generated for the broadcast source supplying the application. If no identical match is found, the user is notified of the fact and the channel with the relevant identification services and databases terminates.

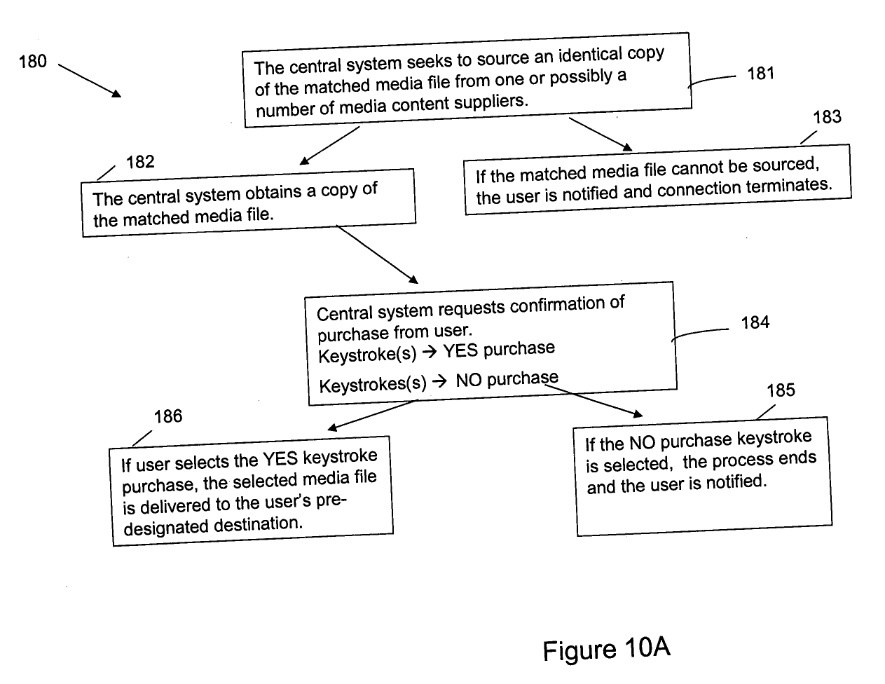

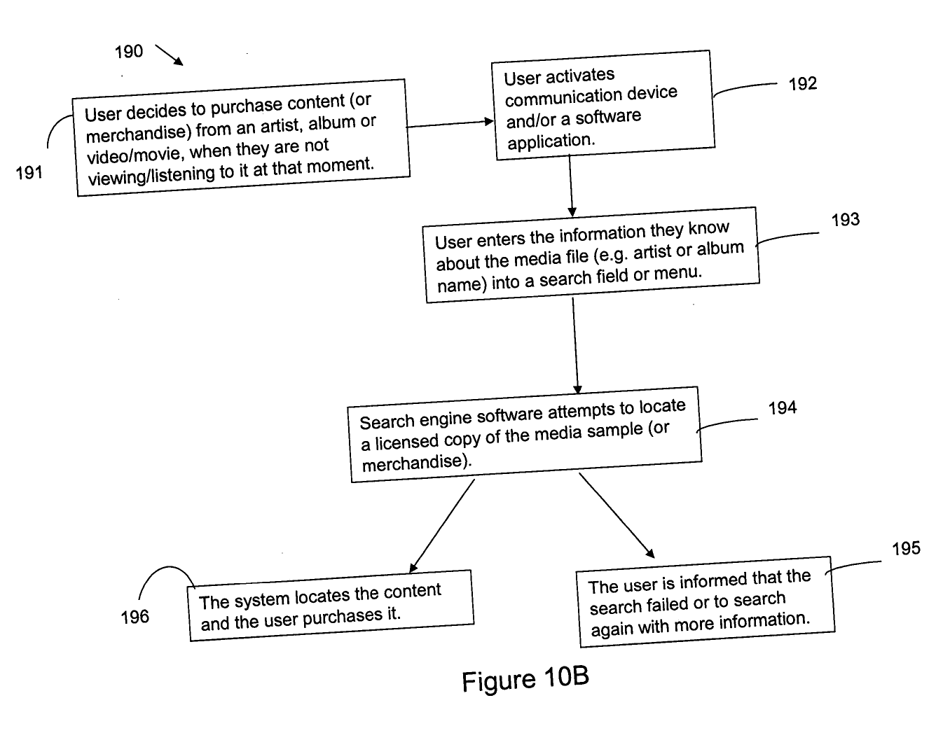

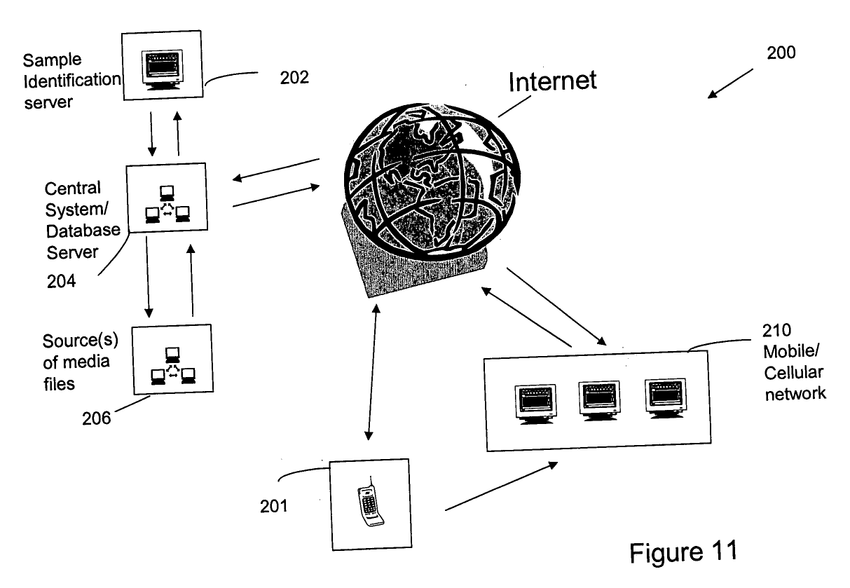

FIG. 10A describes a process 180 of delivering the desired content to the user once the sampled content has been identified and matched using the broadcaster specific application discussed above. In contrast FIG. 10B, describes a process 190 that uses the same broadcaster specific application when the user is not listening to a broadcast source, but still desires to identify and purchase content. An exemplary system 200 for implementing aspects of the processes 180, 190 and some of the other compensation methods discussed above is shown in FIG. 11.

FIG. 10A depicts a method 180 wherein a central system sources the supply of the desired media file from one, or a number of media file content suppliers Step 181 for one of the compensation method disclosed herein using a cellular telephone or other communication device. Upon completion of this search for a source, there are two possible outcomes. An identical copy of the media file is obtained by the central system Step 182 or, an identical match of the media file cannot be sourced by the central database in which case the user is notified and the cell call ends Step 182. If the media file can be sourced, the central system now notifies the user and requests confirmation of purchase Step 184. The user will be requested to enter one keystroke on their cell phone to activate a YES purchase or a second different keystroke to activate a NO purchase Step 184. However, the choice of keystrokes is arbitrary and can vary in different embodiments. There are now two options in the process. A NO purchase terminates the cell call Step 185. A YES purchase confirmation from the user to the central system triggers the electronic downloading of the desired media file to the users pre-designated choice of destination (e.g.; cell phone, PC, AN Other delivery point) Step 186. Details of the user's preferred media content delivery method are communicated to the central system at an early registration step as discussed above. When the media file has been successfully delivered to the user's preferred delivery point, the user is charged for the purchase by means of their pre-designated choice of payment details specified upon registration.

FIG. 10B, describes a method application feature 190 that can be incorporated in different embodiments of the invention including those using playout list synchronization and those using application software provided by unique broadcast sources. The method 190 can be used when a consumer is not listening to a specific broadcast source, but still desires to purchase content. As such the ability to search and buy content using a user's webpage account with a particular broadcast source provides further compensation events for a given broadcaster.

Still referring to FIG. 10B, initially, a potential consumer decides to purchase content (or merchandise) from an artist, album or video/movie, when they are not viewing/listening to it at that moment Step 191. Next, a user activates communication device and/or a software application Step 192. Thus, a media player with pre-loaded software or firmware connected to a PC or a communication device with branded software associated with a particular broadcast source can be used. Next, the user enters the information they know about the media file, such as the artist or album name into a search field or menu accessed via a communication device Step 193. Search engine software running on a PC connected to a media player or a specific application running on a communication device attempts to locate a licensed copy of the media sample (or merchandise) Step 194. If the content of interest cannot be located, the user is informed that the search has failed or to search again with more information Step 195. If the content is found the user is given the option to purchase it Step 196.

A server based system 200 for implementing aspects of the processes discussed above with respect to FIGS. 8-10B, in particular, and some of the other compensation methods discussed above is shown in FIG. 11. A communication device 201 interacts with different servers and databases using various communication channels. A sample identification server 202 can be used to host the algorithms and software needed to identify content elements using samples transmitted from the communication device 201. A central system server 204 can contain licensing and compensation arrangement data that communicates with the source 206 of the individual content elements/media files. In turn, a mobile telephone network 210 or the Internet can be used to facilitate communications between the different system components 202, 204, 206, and 201. However, different arrangements using additional or fewer system components can be implemented as known to those of ordinary skill in the art.

In various embodiments disclosed herein, in addition to the broadcast source, other members of the value chain can be compensated. The value chain includes, but is not limited to the owners of the musical work (usually music publishers), the owners in the sound or audio visual recording (record companies), the broadcaster who provided the application, the content recognition service provider and any other licensee involved. Payment can be made in real time as micro payments or grouped e.g. in daily, weekly or monthly accountings depending on the preferences of the licensors. In contrast with prior compensation schemes, the broadcaster receives a share of the revenue from the music industry even though up until now this sector has been a crucial element in the marketing of new and existing music.

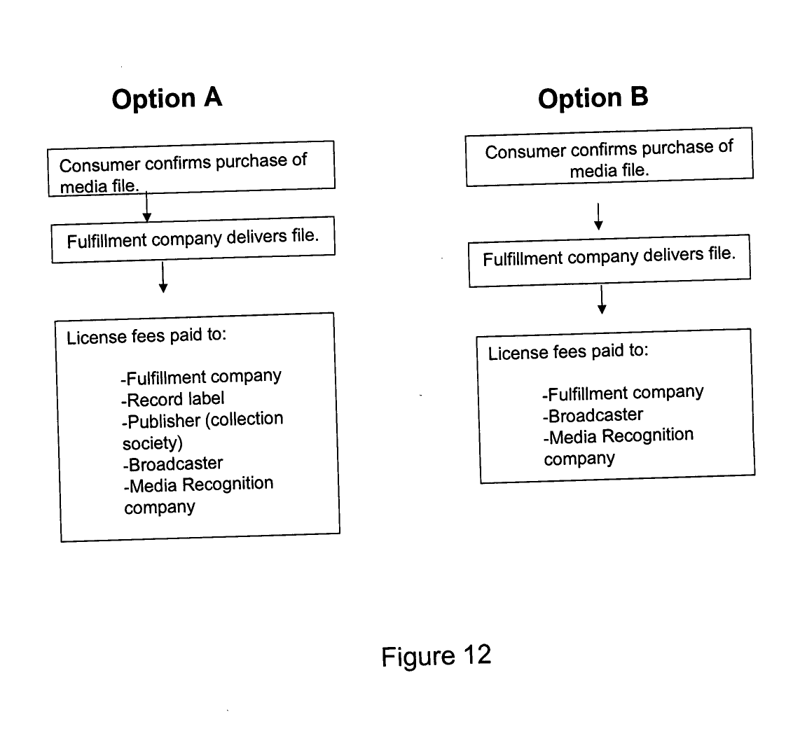

One embodiment depicted in FIG. 12 relates to defining and/or executing the necessary transactions for resolving the legal rights involved among value chain members. These rights can be handled directly with individual record labels and collecting societies (Option A). Processing the purchased media file and paying a royalty per each purchase including a share to the broadcaster are also features of this embodiment. A further embodiment purchases the media files wholesale with all rights cleared from an existing fulfilment house specialising prior to delivering the digital media files. License fees in this embodiment are typically paid to the fulfilment company, the application broadcaster and media recognition company (Option B).

The invention also relates to the software and services that enable the identification and purchase of media files through the device. These may include a web site that offers links to broadcasters for inclusion on their web sites, electronic lockers for consumers and the ability for each participant in the value chain to view and manage their account details. The invention can also provide the software application for the device that is downloaded from the individual broadcaster using an individualized number that is broadcaster specific by territory. The application will have a unique identifier which links it to the original broadcaster which information is later used to compensate that specific broadcaster when the consumer purchases a media file via that device.

Another aspect of the invention relates to an e-commerce system that: contains a business rules engine for broadcasters that allows for differential pricing depending on pre-determined criteria such as: level of interest, specific media file, specific artist, and date of release. The system may use a website or other software application that contains a business rules engine that allows for differential revenue share models for: copyright holders, publishers, record companies, promoters, licensing bodies, content suppliers, broadcasters, sales tax by region, and different currencies. The website or system components identify the media file. The system is also adapted for selling media files, merchandising, event tickets, sponsorship, and market data. As a result the system is designed to remunerate: copyright holders, publishers, record companies, promoters, broadcaster, and royalty clearing houses. This interaction between consumers and other business entities creates revenue opportunities for the broadcaster through: sponsorship deals, and reselling ‘own brand’ media files.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

What is claimed is:

1. A method of compensating a broadcast source, the method comprising:
delivering a plurality of content elements originating from a broadcast source to a receiver;
generating a playout list of the plurality of content elements;
identifying the broadcast source;
identifying one content element of the plurality of content elements; and
compensating the broadcast source if the receiver purchases an item associated with the one content element.

2. The method of claim 1 wherein the playout list is generated by tracking changes in the plurality of content elements over time to identify different content elements.

3. The method of claim 1 further comprising the steps of:
directing the user to a webpage and granting access to the webpage using a character string associated with the receiver.

4. The method of claim 1 further comprising the step of receiving a message sent to the receiver containing information relating to the one content element.

5. The method of claim 1 wherein the unique identifier is a phone number associated with the broadcast source and the receiver is a portable communication device.

6. The method of claim 1 wherein the item is a downloadable version of the one content element.

7. The method of claim 1 wherein the item is grouped on a webpage with additional purchasable items associated with the one content element.

8. The method of claim 1 wherein the item and the one content element are selected from the group consisting of a song, a ringtone, a game, software, a graphic, a concert ticket, an article of clothing, movie tickets, a consumer product, food, a coupon, a rebate, and combinations thereof.

9. A system for exchanging data between a user and a content source, the system comprising:
a transmission device adapted to update and transmit a playout list, the playout list comprising a chronological arrangement of content broadcast by the content source; and
a server adapted to interface with the transmission device and a user's communication device such that the user is directed to the server using a unique content source identifier adapted for use with the communication device and wherein the playout list is accessed to identify content selected by the user.

10. The system of claim 9 wherein the server comprises
content available for purchase by the user, and
a user specific webpage accessible using a unique user identifier.

11. The system of claim 9 wherein the content source is a radio station and the communication device is a cellular telephone.

12. The system of claim 10 wherein the unique user identifier is the user's cellular telephone number.

13. The system of claim 9 wherein the unique identifier is a phone number associated with the content source.

14. The system of claim 9 wherein the communication device is selected from the group consisting of a cellular telephone, a personal digital assistant, a media player, and a Personal Computer (PC).

15. The system of claim 9 wherein the server is adapted to enable purchase of content selected by the user in response to a broadcast from the content source and to remit compensation to the content source.

16. The system of claim 9 wherein the server is adapted to transmit a message to the communication device containing information relating to a portion of the content broadcast by the content source.

17. A method adapted for use on a mobile device, which identifies specific content and a broadcast source, the method comprising the steps of:
executing a program using the mobile device in response to at least one keystroke;
communicating with a database adapted for identifying the specific content using a playout list provided by the broadcast source;
communicating with a server adapted for hosting individual user account details;
receiving information about a purchasable item associated with the specific content from the server; and
remitting compensation to the broadcast source in response to purchase of the item.

18. The method of claim 17 wherein the item is selected from the group consisting of a song, a ringtone, a game, software, a graphic, a concert ticket, an article of clothing, movie tickets, a consumer product, food, a coupon, a rebate, and combinations thereof.

19. The method of claim 17 wherein the mobile device is selected from the group consisting of a cellular telephone, a personal digital assistant, a media player, and a Personal Computer.

20. The method of claim 17 wherein the broadcast source is a radio station, a television station or an advertiser.

21. A method of targeted advertising, the method comprising steps of:
broadcasting a chronologically arranged sequence of content to a potential consumer, the sequence broadcast from a unique content source;
selecting an element from the sequence by the consumer using a communication device;
identifying the selected element using chronologically arranged data corresponding to the chronological arranged sequence of content provided by the unique content source;
providing to the consumer a plurality of purchasing options relating to the selected element; and
compensating the unique content source if the consumer purchases an item in response to the purchasing options provided

22. The method of claim 21 further comprising the step of compensating the unique content source if the consumer requests more information about the element.

23. The method of claim 21 wherein the element is selected from the group consisting of a song, a ringtone, a game, software, a graphic, a concert ticket, an article of clothing, movie tickets, a consumer product, food, a coupon, a rebate, and combinations thereof.
